(19) United States
(12) Patent Application Publication
(10) Pub. No.: US 2008/0175961 A1
(43) Pub. Date: Jul. 24, 2008

(54) Packaged-corn-on-the-cob

(75) Inventors: Daniel Whittles, Palm City, FL (US); Hunter W. Wolcott, Stuart, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(73) Assignee: Phaselocd, Inc.

(21) Appl. No.: 11/743,225

(22) Filed: May 2, 2007

Related U.S. Application Data
(60) Provisional application No. 60/897,206, filed on Jan. 24, 2007.

(51) Int. Cl. B65B 25/04; A23B 7/00; B65D 85/00

(52) U.S. Cl. 426/115; 206/459.5; 426/106; 426/119; 426/123; 426/234; 426/411; 53/396

(57) ABSTRACT

Microwavable and/or boilable packaged corn-on-the-cob includes one or more ears of fresh, shucked or partially shucked corn, each individually enveloped in an at least partially gas-impermeable and at least partially moisture impermeable transparent film that may be suited for microwave cooking and boiling and may include an easy-open strip. Each of the enveloped one or more ears is placed vertically in a shank-down orientation in a holder having at least one compartment for holding an ear of corn. The at least one ear of corn can be secured in the compartment by a suitable means. Units of packaged corn can be placed into a shipping container with the ears arranged vertically with the shank end down to minimize physical damage during shipping.

### CROSS-REFERENCE TO RELATED APPLICATIONS

The present application claims the priority of U.S. provisional patent application Ser. No. 60/897,206 filed on Jan. 24, 2007.

### FIELD OF THE INVENTION

The invention relates to the fields of agriculture and produce packaging. More particularly, the invention relates to fresh corn-on-the-cob that has been packaged in an appealing manner that protects it from damage, preserves its freshness, enhances its safety, and increases user convenience.

### BACKGROUND OF THE INVENTION

Fresh corn-on-the-cob can be an esthetically appealing, sweet, and juicy treat. Too often, however, fresh corn-on-the-cob proves to be bruised, dry, and bland. Corn-on-the cob quality at the point of sale is dependent on packaging and shipping conditions. Conventional methods of packaging and shipping corn-on-the-cob involve simply throwing several dozens of recently picked loose ears horizontally (where weight and impacts are borne by the soft kernels) into wooden or plastic crates, which are then stacked and loaded onto transport vehicles. This process leads to high levels of physical damage (e.g., bruising or kernel bursting) to the product. Because the freshness of corn-on-the-cob begins to deteriorate immediately after picking, conventional packaging and shipping methods can lead to loss of juiciness through evaporation and loss of sweetness due to the conversion of sugars to flavorless starch caused by oxidation and residual metabolism.

Exacerbating the above, conventional methods of packaging fresh corn-on-the-cob make it difficult for a retail consumer to discern the difference between high and low quality corn-on-the-cob. In grocery stores and produce markets, fresh corn-on-the-cob is generally sold in two ways: (i) unpackaged, loose, unshucked ears or (ii) shucked or partially shucked ears packaged in a tray. While the former method preserves freshness better than the latter, it is less convenient because the consumer must shuck the corn prior to cooking. In addition, because husks entirely envelope each ear of unshucked corn, it is difficult for the consumer to assess the quality of the product. Pre-shucking and horizontally packaging 3 to 4 ears of corn-on-the cob in trays over-wrapped with plastic film allows consumers to readily determine the physical attributes of some parts of the product. Unfortunately, this packaging method also increases exposure of the kernels to air, leading to an increased rate of moisture loss due to evaporation and sugar-to-starch conversion. This problem is aggravated by the common practice of cutting or sawing of the ears—a process which increases the likelihood of microbiological growth in the corn. Cutting the ear also opens it up to oxidation, which rapidly robs corn of its sugar content (it can turn to starch within hours), speeds moisture loss, and results in significant waste. In addition, compression of those portions of the ears that abut each other and the tray can cause physical damage to the product. Further, because tray-packed corn is usually arranged in 3 or 4 ears per package, if less than all the ears in the package are used at a single meal, the remaining ears rapidly deteriorate in the open package.

In the foodservice (restaurant, cafeteria, or industrial) sector, fresh corn-on-the-cob is generally received as unpackaged, loose, unshucked ears in a crate. This again makes discerning the quality of the corn difficult and requires shucking. In a high volume situation, shucking can be a time consuming process. Although fresh corn-on-the-cob is readily available in grocery stores, produces, markets, and restaurants, it is rarely, if ever, sold in convenience or specialty stores. A chief reason for this is that conventional corn-on-the-cob packaging methods are not compatible with what most convenience store customers are looking for—i.e., a ready-to-cook (microwavable) product packaged in a single serving.

Another factor affecting the quality of fresh corn-on-the-cob is the method of cooking. For example, exposure of corn-on-the-cob to water and heat during boiling exposes can cause the product to lose taste and texture through osmosis whereby (i) flavor is lost as the sugar and dissolved solids in each kernel flow into the surrounding water and (ii) texture deteriorates as entering water swells, expands, and sometimes bursts the kernels. The effects of osmosis can be avoided by cooking fresh corn-on-the-cob by microwave heating although even this gentler way of cooking can cause loss of moisture and kernel bursting due to pressure caused by heating water vapor inside the kernels.

### SUMMARY

A new way of packaging freshly-picked corn-on-the-cob has been developed that reduces sugar and moisture loss, protects the kernels from physical damage, allows a consumer to easily view the quality of the individual kernels before purchase, facilitates microwave cooking or boiling of the product, reduces osmotic losses during boiling, reduces moisture loss when microwaving, and allows use of less than all the ears in any multiple-ear package without accelerating the deterioration of the unused ears. As described in more detail below, an exemplary embodiment of the packaged corn-on-the-cob of the invention includes one or more ears of fresh, shucked or partially shucked corn, each individually enveloped in an at least partially gas-impermeable and at least partially moisture impermeable transparent film. The film is preferably safe for microwave and boiling and includes an easy-open strip to facilitate microwave cooking or boiling by the consumer. Each of the enveloped one or more ears is placed vertically in a shank-down orientation in a holder having at least one compartment for holding an ear of corn. The at least partially gas-impermeable and at least partially moisture impermeable transparent film reduces sugar and moisture loss, allows a consumer to easily view the quality of the individual kernels before purchase, reduces osmotic losses during boiling, reduces moisture loss when microwaving, and allows use of less than all the ears in any multiple-ear package without accelerating the deterioration of the unused ears. The film, along with the easy open strip, facilitates preparing the product by microwave cooking or boiling. The vertical placement of the ears in a shank-down orientation in a holder protects the product from physical damage.

Accordingly, the invention features packaged corn including: at least a first at least partially shucked ear of corn-on-the-cob; a first wrapping enveloping the at least partially shucked ear, the wrapping including a transparent film (e.g., one that is at least partially gas impermeable and at least partially moisture impermeable, microwave safe, and/or safe for boiling) and, optionally, an easy open tear strip; and a corn holder including a holding compartment (or a plurality of compartments such as 2, 4, 6, 8, or 12-48 compartments) having vertically positioned therein the wrapped at least partially shucked ear and, optionally, a handle suitable for grasping by a hand. The first at least partially shucked ear of corn-on-the-cob can be positioned on a basting tray having a length at least about the length of the ear of corn-on-the-cob and a width at least about the width of the ear of corn-on-the-cob, and the first wrapping can envelope both the basting tray and the at least partially shucked ear.

The packaged corn can further include: at least a second ear of at least partially shucked corn-on-the-cob; a second wrapping enveloping the second ear, the first and second wrappings each including a transparent film; and a corn holder including at least a first ear holding compartment and a second ear holding compartment, wherein the first ear is vertically positioned in the first ear holding compartment and the second ear is vertically positioned in the second ear holding compartment. The first and second ears can be vertically positioned in the corn holder in a shank down orientation.

In the packaged corn, the first compartment can have a height less than the length of the first ear and the corn holder can include a fastener for securing the first ear in the first compartment. The first compartment might also be colored black or another color that provides high contrast between the corn and the holder.

The packaged corn can also include a seasoning (e.g., one included within a packet affixed to or contained within the corn holder) and/or an ear holding device including a gripping end adapted to be gripped by a person and a pointed end adapted to be inserted into an ear of corn-on-the-cob.

In another aspect, the invention features a method including the steps of: (a) picking a first ear of corn-on-the-cob; (b) removing at least some husk from the first ear to yield an at least partially shucked first ear; (c) enveloping the at least partially shucked first ear in a first wrapping comprising a transparent film; and (d) vertically positioning the enveloped first ear in a first ear holding compartment of a corn holder. The foregoing method can further include the steps of: (a′) picking a second ear of corn-on-the-cob; (b′) removing at least some husk from the second ear to yield an at least partially shucked second ear; (c′) enveloping the at least partially shucked second ear in a second wrapping comprising the transparent film; and (d′) vertically positioning the enveloped second ear in a second ear holding compartment of the corn holder.

In another aspect, the invention features a method including the steps of: (a) picking a first ear of corn-on-the-cob; (b) removing at least some husk from the first ear to yield an at least partially shucked first ear; (c) placing the at least partially shucked ear of corn into a tray; (d) enveloping the at least partially shucked first ear plus the tray in a first wrapping comprising a transparent film; and (e) vertically positioning the enveloped first ear and tray in a first ear holding compartment of a corn holder.

Another method of the invention includes the steps of: (a) obtaining corn packaged as described above; (b) cooking the wrapped first ear in a microwave oven; and (c) removing the wrapping (e.g., via an easy-open strip) from the first ear.

Another method of the invention includes the steps of: (a) obtaining corn packaged as described above; (b) cooking the wrapped first ear in boiling water; and (c) removing the wrapping (e.g., via an easy-open strip) from the first ear.

Also within the invention is a shipping container including a plurality of units of packaged corn, wherein each of said units of packaged corn includes: at least a first ear and a second ear of corn-on-the-cob, wherein the first and second ear are at least partially shucked; a first wrapping enveloping the first ear and a second wrapping enveloping the second ear, the wrappings each including a transparent film; and a corn holder including at least a first ear holding compartment and a second ear holding compartment, wherein the first ear is vertically positioned in the first ear holding compartment and the second ear is vertically positioned in the second ear holding compartment, wherein the shipping container is marked with a label indicating which side of the container should remain up during shipping, and wherein each of the plurality of units of packaged corn is placed in the shipping container with the ears of corn arranged vertically when the side of the container that should remain up during shipping is up.

Another aspect of the invention is a method including the steps of: (a) obtaining a plurality of units of packaged corn, each of said units of packaged corn including: at least a first ear and a second ear of corn-on-the-cob, wherein the first and second ear are at least partially shucked; a first wrapping enveloping the first ear and a second wrapping enveloping the second ear, the wrappings each including a transparent film; and a corn holder including at least a first ear holding compartment and a second ear holding compartment, wherein the first ear is vertically positioned in the first ear holding compartment and the second ear is vertically positioned in the second ear holding compartment, (b) obtaining a shipping container marked with a label indicating which side of the container should remain up during shipping; (c) packing each of the plurality of units of packaged corn in the shipping container with the ears of corn arranged vertically when the side of the container that should remain up during shipping is up; and (d) transporting the packed shipping container from a first location to a second location located at least 1 kilometer from the first location.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a schematic illustration of a two-ear packaged corn embodiment of the invention.

FIG. 2 is a schematic illustration of a four-ear packaged corn embodiment of the invention.

FIG. 3A is a schematic illustration of a variable-geometry corn support insert.

FIG. 3B is a cut-away schematic illustration of the corn support insert of FIG. 3A used in conjunction with the packaged corn of the embodiment shown in FIG. 2.

FIG. 4 is a schematic illustration of an ear of corn positioned in a tray wherein the ear/tray combination is enveloped in a wrapping.

FIG. 5 is a schematic illustration of a corn packaging device that includes a corn support insert placed inside a corn holder.

FIG. 6 is a schematic illustration of corn packaged in the corn packaging device shown in FIG. 5.

### DETAILED DESCRIPTION

The invention provides packaged corn-on-the-cob, shipping containers for shipping corn-on-the-cob, methods for dividing containers into compartments for shipping corn-on-the-cob, methods for packaging corn-on-the-cob, methods for cooking corn-on-the-cob, and methods for shipping corn-on-the-cob. The below described preferred embodiments illustrate adaptations of the foregoing. Nonetheless, from the description of these embodiments, other aspects of the invention can be made and/or practiced based on the description provided below.

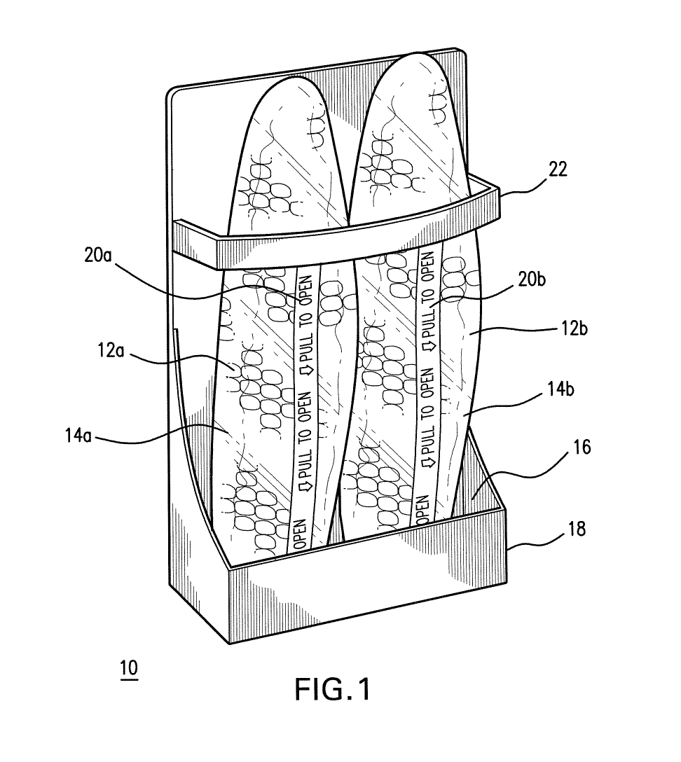

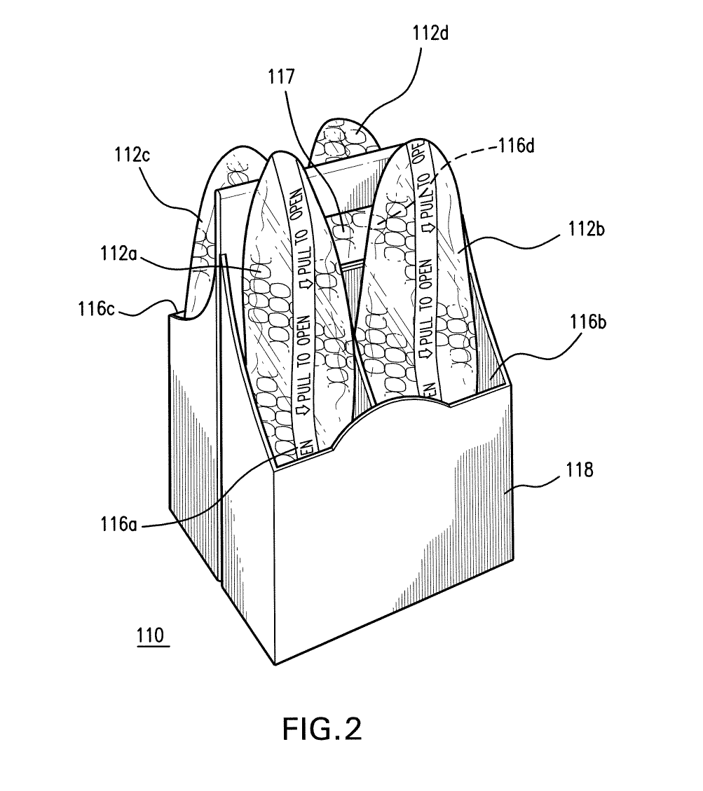

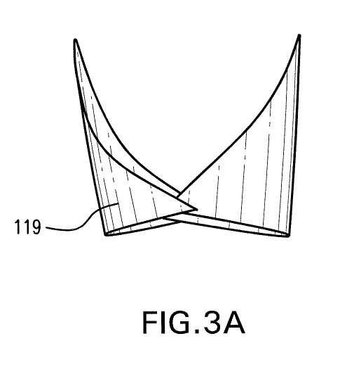

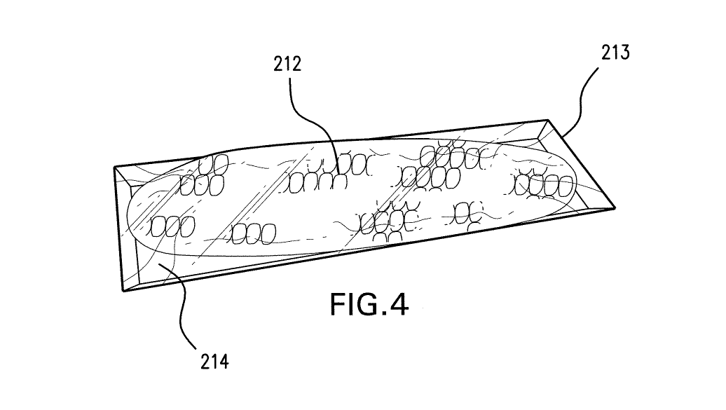

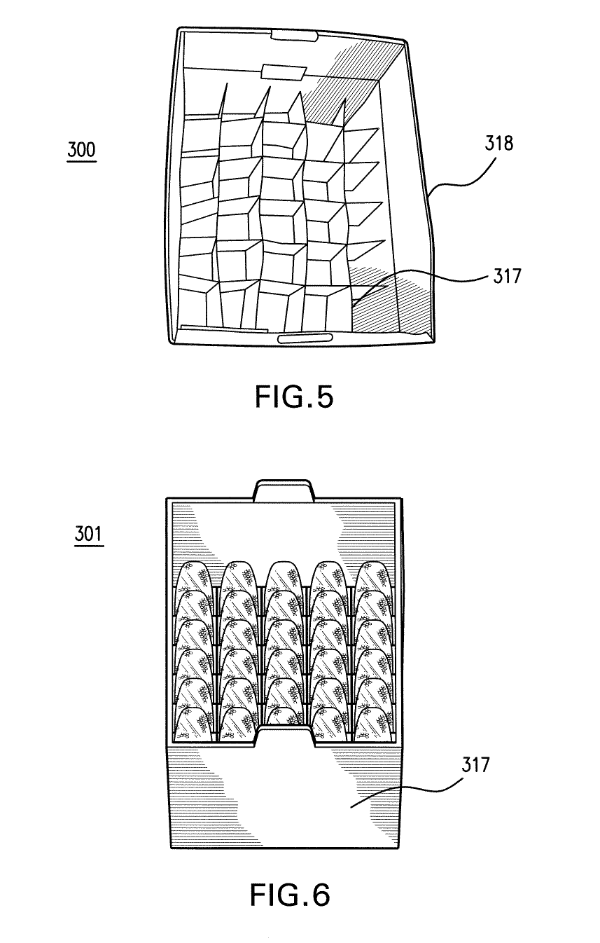

Referring now to FIGS. 1-6, four embodiments of packaged corn-on-the cob are shown. Those embodiments shown in FIGS. 1 and 2 are primarily designed for sale in a retail setting such as a grocery store or produce market where a consumer would want to buy between about 2-12 ears of corn. The embodiment shown in FIG. 3 is intended for sale in a convenience store setting where a consumer would want to purchase a single ear of corn and have it cooked at the point of purchase. The embodiment shown in FIGS. 5 and 6 is designed for sale to a foodservice provider such as a restaurant or cafeteria where a large number of ears would be prepared. Each of the embodiments shown in FIGS. 1-6 shares certain components including at least one ear of corn-on-the-cob, a wrapping enveloping each ear, and a corn holding device.

In the embodiment shown in FIG. 1, packaged corn 10 includes two ears of corn-on-the cob 12a, 12b each individually enveloped in wrappings 14a, 14b and placed vertically (preferably shank down) in a holding compartment 16 of a corn holder 18. To facilitate opening after cooking, the wrappings 14a, 14b have integrated therein easy-open tear strips 20a, 20b. In the embodiment shown in FIG. 2, packaged corn 110 includes four ears of corn-on-the-cob 112a, 112b, 112c, 112d arranged in a shank down position in a corn holder 116 having four corn holding compartments 118a, 118b, 118c, 118d and a handle 117 (i.e., an aperture formed in the top of the holder 116) that facilitates a consumer picking up and carrying the packaged corn. In these an other embodiments of packaged corn intended for sale in a retail setting, it is preferred that the corn holding compartment generally have a height less than the length of the corresponding ear of corn such that the top portion of the ear of corn protrudes from the compartment for easy visualization by a consumer.

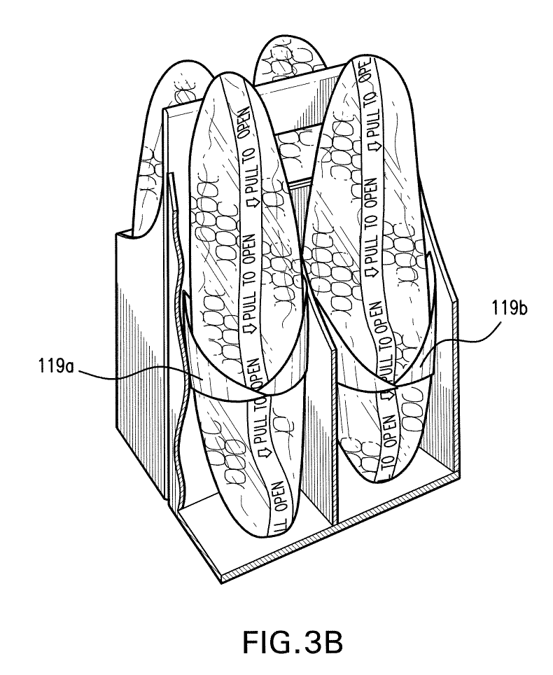

Referring now to FIG. 4, in an embodiment particularly suited for sale in a convenience store setting, a single ear of corn-on-the-cob 212 is placed into a basting tray 213 and the resulting corn in tray combination is enveloped in a wrapping 214. When placed horizontally as shown in FIG. 4, the basting tray 213 can be used to hold a seasoning (e.g., melted butter). The ear of corn-on-the-cob 212 can be coated with seasoning by rotating it in the seasoning in the tray 213. The basting tray 213 can be made of any suitable material such as a moisture-resistant plastic (e.g., polylactic acid or polypropylene plastic) or thermoformed corrugated cardboard. To enhance the esthetic appeal of the product, the interior and/or exterior of the basting tray 213 may be of a dark color (e.g., black) to provide contrast with the color of the corn.

In the embodiment shown in FIGS. 5 and 6, a corn packaging device 300 includes a corn support insert 319 placed inside a corn holder 318. The insert 319 defines a plurality of corn holding compartments into which individually wrapped ears of corn can be inserted (e.g., shank down) to yield packaged corn 301 as shown in FIG. 6. In this embodiment, corn packaging device 300 is designed for transport to and use by a foodservice/restaurant user. Accordingly, the corn support insert 319 typically would divide the interior of corn holder 318 into 12 or more (e.g., 12, 14, 16, 18, 20, 24, 36, 48, 72, 144 or more) compartments. The corn support insert 319 and the corn holder 318 can be made of any suitable material, e.g., corrugated cardboard or plastic. Although not required, the plurality of compartments can each have roughly the same dimensions (e.g., sized to accommodate an ear of corn in a shank-down position) and be arranged symmetrically. Preferably, for convenience in the shipping process, the corn holder for use in a foodservice setting is dimensioned to fit the footprint of standard size pallets.

The corn-on-the-cob for use in the various embodiments of the invention can be of any type suitable for eating. Examples of suitable corn include sweet corn such as normal sugary, sugary enhancer, and super sweet varieties. In general, for better taste, sweet or super sweet corn is preferred. Although any grade of corn might be used in the invention, high quality (e.g., USDA Fancy) corn is preferred. The size of the ears can be any suitable for eating the kernels on the cob. In general, larger ears are preferred, e.g., at least 6, 7, 8, 9, or 10 inches in length. For embodiments where multiple ears are located in a single holder, it is preferred that the ears be roughly the same size (e.g., less than about 5-10% variation in any single dimension). The corn may be of any color including yellow, white, red, bi-color, or tri-color.

It is also preferred that the corn-on-the-cob be fresh-picked (i.e., enveloped in a wrapping within less than 15 minutes, 30 minutes, 1 hour, 2 hours, 3 hours, 6 hours, 12 hours, or 1 day after picking). Shorter times between picking and enveloping are preferred to retain maximum freshness. Typically, before enveloping, picked corn is pre-cooled to retard respiration, shucked (at least some, but preferably all of the husk and silk is removed), and washed. The washing step is preferably thorough enough that no additional washing is required prior to consumption. The pre-cooling step can be any that reduces the metabolic rate of the corn to retard the sugar-to-starch conversion rate, e.g., corn is immersed in cold water or wetted and vacuum-cooled until the corn is cooled to about 0-5° C. within about an hour of picking. It is also preferred that after the corn is pre-cooled, it be maintained at less than about 10° C. (preferably at or near 0° C.) to minimize respiration.

Prior to placing in the corn holder, the ear(s) of corn-on-the-cob are individually enveloped in a wrapping e.g., by heat-mediated shrink wrapping. It is preferred that the wrapping be envelope the ear of corn tightly enough to minimize the amount of space between the corn's kernels and the wrapping. The wrapping can be made of any suitable material able to reduce moisture and carbon dioxide loss from the corn (e.g., made of a partially gas-impermeable, partially moisture impermeable film) and also be compatible with microwave cooking or boiling. The wrapping can be a micro-perforated film. Films that provide the optimal oxygen transfer rate (OTR), carbon dioxide transfer rate (CTR) and water vapor transfer rate (WVTR) for maximizing the freshness of corn are preferred. As one specific example, a fog free rd45 or RD106/60 gauge shrink wrap film manufactured by Sealed Air might be used. Although not required, to facilitate opening after microwave cooking or boiling, it is preferred that the wrapping have an embedded tear strip or other easy-open component.

As illustrated in the figures, the corn holder of the invention can take on a wide variety of arrangements. The corn holder 18 shown in FIG. 1 has a single corn holding compartment configured to hold the two ears of corn 12a, 12b. In comparison, the corn holder 118 shown in FIG. 2 has four corn holding compartments 116a, 116b, 116c, 116d each configured to a single ear of corn; the corn holder shown in FIG. 3 is a tray 213 for holding one ear of corn 212; and the corn holder 318 of FIGS. 5-6 is carton into which is inserted a corn support insert that defines several different corn holding compartments. In other embodiments, a corn holder can have one or more (e.g., 1, 2, 3, 4, 5, 6, 7, 8, 9, 10, 11, or 12 for packaged corn intended to be sold to a retail customer; or 12, 14, 16, 18, 24, 30, 36, 40, 48, 96, 144 or more for packaged corn intended to be sold to an foodservice or restaurant user) ear holding compartments into which the ears are placed (generally one or two ears per compartment). The compartments can be any suitable shape or size such as a generally cuboidal or rectangular cuboidal shape. The corn holder is preferably made entirely of environmentally friendly, sustainable material such as recyclable plastic, paper, cardboard, or corrugated cardboard.

The corn holder can feature a means for securing the ears in the compartments, e.g. a tie or a tab (e.g., one that can be removed or pressed flat against the holder when not needed such as when large ears are used). As shown in FIGS. 3A and 3B, a corn support insert 119 can be used to secure the ears of corn 112a, 112b, 112c, 112d in each holding compartment 118a, 118b, 118c, 118d, respectively. The corn support insert 119 shown in FIG. 3 is made of two triangular planar pieces of a semi-rigid material such as plastic or paper that are affixed together at about their base vertices to form an aperture through which an ear of corn can be inserted. By adjusting the position of the insert 119 on an ear of corn, the inserts diameter can be increased or decreased so that the ear of corn be securely fitted into the holding compartment of the holder.

In those embodiments intended primarily for sale to a retail customer, the corn holding compartment generally has a height less than the length of the corresponding ear of corn such that the top portion of the ear of corn protrudes from the compartment for easy visualization by a consumer. In those embodiments intended primarily for sale to a foodservice/restaurant customer, the at least one compartment generally has a height greater than the length of the corresponding ear of corn such that the top portion of the ear of corn will be protected with no need to place the at least one compartment into another container for shipping.

To provide contrast to assist a consumer in evaluating the quality of the corn, the corn holder can have a dark color (e.g., a black corn holding compartment). The corn holder might also feature a handle (e.g., one having an aperture) to facilitate carrying the packaged corn.

In addition to the above, the packaged corn of the invention might include other components such as seasoning, an ear holding device, and/or a moisture-resistant pouch. A seasoning such as butter, spices, herbs, or sauces can be included in any suitable holder, e.g., a packet affixed to or contained within the corn holder. The ear holding device can be any device that can be used to assist a consumer in grasping an ear of corn, e.g., a round piece of wood or plastic about 2.5″ to 4″ in total length and about ¼″ to ⅜″ in diameter having a gripping end for holding by a consumer and a pointed end which can be inserted into the shank end of the corn. The packaged corn can also include a tray which may be used as a basting dish for seasoning and which may be packaged within the enveloping film or separately such as within a packet affixed to or contained within the corn holder. In addition, the packaged corn can also include a moisture resistant pouch or bag which may be used to carry the at least one ear of corn after cooking together with seasonings to provide a convenient way to eat seasoned corn away from the home with less chance of mess or spills, and which pouch or bag may be packaged together with the corn or separately such as within a packet affixed to or contained within the corn holder.

For shipping between two locations (e.g., a processing center near a cornfield and a retail market or restaurant separated by a distance of 1, 2, 3, 10, 50, 100 or more kilometers), several units (e.g., 8, 10, 12, 16, 24, 30 48, 96 or more) of the packaged corn of the invention are preferably placed in a shipping container. To minimize damage from impacts during the shipping process, the shipping container is marked with a label indicating which side of the container should remain up during shipping (e.g., a marking of “this side up” and an arrow pointing to the “up” side), and all (or at least most) of the units of packaged corn are placed in the shipping container with the ears of corn arranged vertically (shank side down) when the side of the container that should remain up during shipping is up.

The packaged corn can be made by harvesting at least one ear of fresh corn-on-the-cob; completely or partially shucking the at least one ear; washing the at least one ear; shortly thereafter (e.g., within less than about 15 minutes, 30 minutes, 1 hour, 2 hours, 3 hours, 6 hours, 12 hours, or 1 day) tightly enveloping the at least one ear in a transparent film that is at least partially gas-impermeable and at least partially moisture impermeable; and placing the film-enveloped at least one ear in a shank-down, vertical orientation in a holder having one or more ear-holding compartments. In an alternate embodiment, the at least one ear is first placed into a tray and then the combined at least one ear plus tray is tightly enveloped in a transparent film that is at least partially gas-impermeable and at least partially moisture impermeable.

The enveloping step preserves the freshness of the at least one ear and allows the product to be easily inspected for physical quality. Preferably, the ear of corn is pre-cooled to about 0° C. (e.g., using cold water) immediately after picking (or within 1, 2, 3, or 4 hours of picking) to reduce the corn's metabolism rate. It is also preferred to keep the ears cold (e.g., about 10-10° C.) throughout the shipping and display steps. The placement of the at least one ear in a shank down, vertical orientation prevents damage to the corn caused by the kernels abutting the packaging as seen in horizontally packaged corn where all the kernels on one side of the ear rest against the packaging.

The packaged corn-on-the-cob described above is ideally suited either for microwave cooking or for boiling. In a method for cooking such corn, one or more of the individually wrapped ears are placed unwrapped in a microwave oven or in boiling water. The microwave oven is then used to cook the corn for an appropriate amount of time (e.g., about 1 minute at high power for one ear). If boiling is chosen, the wrapped ear(s) are placed in a pan containing several inches of boiling water for 3-4 minutes. The cooked but still wrapped corn is then removed from the microwave oven or boiling water and then allowed to cool so that it can be handled, the wrapping is then removed (e.g., by unzipping an easy-open strip embedded in the wrapping). The corn is then ready to be seasoned (if desired) and then eaten. In alternate embodiments, provided an appropriate wrapping is used, the wrapped corn is steamed, rather than cooked by microwave oven or by boiling.

The packaged corn of the invention may be placed in a shipping container for shipping. For example, a plurality of units of packaged corn as described above can be obtained and placed into a shipping container marked with a label indicating which side of the container should remain up during shipping. The units of packaged corn are positioned in the shipping container with the ears of corn arranged vertically (shank down) when the side of the container that should remain up during shipping is up. In this way, damage to the corn is minimized as most of the force applied to the corn in this arrangement is on the shank, not the kernels.

### Other Embodiments

It is to be understood that while the invention has been described in conjunction with the detailed description thereof, the foregoing description is intended to illustrate and not limit the scope of the invention, which is defined by the scope of the appended claims. For example, although the foregoing describes products and methods which utilize corn, other food products or produce, especially those having an elongated shape, might be substituted for corn in the invention. In addition to or in conjunction with the above-described embodiments, the packaged corn might also be sold with small sharpened sticks to hold the corn, and/or with a self-basting butter-seasoning and corn tray or other holder. Other aspects, advantages, and modifications are within the scope of the following claims.

What is claimed is:

1. Packaged corn comprising:
at least a first at least partially shucked ear of corn-on-the-cob;
a first wrapping enveloping the at least partially shucked ear, the wrapping comprising a transparent film; and
a corn holder comprising a holding compartment having vertically positioned therein the wrapped at least partially shucked ear.

2. The packaged corn of claim 1, wherein the first at least partially shucked ear of corn-on-the-cob is positioned on a basting tray, the basting tray having a length at least about the length of the ear of corn-on-the-cob and a width at least about the width of the ear of corn-on-the-cob.

3. The packaged corn of claim 2, wherein the first wrapping envelopes both the basting tray and the at least partially shucked ear.

4. The packaged corn of claim 1 further comprising:
at least a second ear of at least partially shucked corn-on-the-cob;
a second wrapping enveloping the second ear, the first and second wrappings each comprising a transparent film; and
a corn holder comprising at least a first ear holding compartment and a second ear holding compartment, wherein the first ear is vertically positioned in the first ear holding compartment and the second ear is vertically positioned in the second ear holding compartment.

5. The packaged corn of claim 4, wherein the transparent film is at least partially gas impermeable and at least partially moisture impermeable.

6. The packaged corn of claim 4, wherein the transparent film is microwave safe.

7. The packaged corn of claim 4, wherein the transparent film is safe for boiling.

8. The packaged corn of claim 1, wherein the wrapping comprises an easy open tear strip.

9. The packaged corn of claim 1, wherein the corn holder further comprises a handle suitable for grasping by a hand.

10. The packaged corn of claim 2, wherein the first and second ears are vertically positioned in the corn holder in a shank down orientation.

11. The packaged corn of claim 2, wherein the first compartment has a height less than the length of the first ear.

12. The packaged corn of claim 2, wherein the corn holder further comprises a fastener for securing the first ear in the first compartment.

13. The packaged corn of claim 1, wherein the corn holder has a plurality of compartments.

14. The packaged corn of claim 13, wherein plurality is selected from the group consisting of 2, 4, and 6.

15. The packaged corn of claim 13, wherein plurality is 12 to 48 and the corn holder comprises a container having therein a corn support insert that defines the plurality of compartments.

16. The packaged corn of claim 1, wherein the first compartment is colored black.

17. The packaged corn of claim 2, further comprising a seasoning.

18. The packaged corn of claim 17, wherein the seasoning is comprised within a packet affixed to or contained within the corn holder.

19. The packaged corn of claim 2, further comprising a ear holding device, the ear holding device comprising a gripping end adapted to be gripped by a person and a pointed end adapted to be inserted into an ear of corn-on-the-cob.

20. A method comprising the steps of:
(a) picking a first ear of corn-on-the-cob;
(b) removing at least some husk from the first ear to yield an at least partially shucked first ear;
(c) enveloping the at least partially shucked first ear in a first wrapping comprising a transparent film; and
(d) vertically positioning the enveloped first ear in a first ear holding compartment of a corn holder.

21. The method of claim 20, further comprising the steps of:
(a′) picking a second ear of corn-on-the-cob;
(b′) removing at least some husk from the second ear to yield an at least partially shucked second ear;
(c′) enveloping the at least partially shucked second ear in a second wrapping comprising the transparent film; and
(d′) vertically positioning the enveloped second ear in a second ear holding compartment of the corn holder.

22. A method comprising the steps of:
(a) picking a first ear of corn-on-the-cob;
(b) removing at least some husk from the first ear to yield an at least partially shucked first ear;
(c) placing the at least partially shucked first ear into a tray;
(d) enveloping the at least partially shucked first ear and tray in a first wrapping comprising a transparent film; and
(e) vertically positioning the enveloped first ear and tray in a compartment of a corn holder.

23. A method comprising the steps of:
(a) obtaining the packaged corn of claim 1;
(b) cooking the wrapped first ear by microwave oven, boiling, or steaming; and
(c) removing the wrapping from the cooked first ear.

24. The method of claim 23, wherein the wrapping comprises an easy-open strip and the step (c) comprises opening the easy-open strip.

25. A shipping container comprising a plurality of units of packaged corn, each of said units of packaged corn comprising:
at least a first ear and a second ear of corn-on-the-cob, wherein the first and second ear are at least partially shucked;
a first wrapping enveloping the first ear and a second wrapping enveloping the second ear, the wrappings each comprising a transparent film; and
a corn holder comprising at least a first ear holding compartment and a second ear holding compartment, wherein the first ear is vertically positioned in the first ear holding compartment and the second ear is vertically positioned in the second ear holding compartment,
wherein the shipping container is marked with a label indicating which side of the container should remain up during shipping, and
wherein each of the plurality of units of packaged corn is placed in the shipping container with the ears of corn arranged vertically when the side of the container that should remain up during shipping is up.

26. A method comprising the steps of:
(a) obtaining a plurality of units of packaged corn, each of said units of packaged corn comprising:
at least a first ear and a second ear of corn-on-the-cob, wherein the first and second ear are at least partially shucked;
a first wrapping enveloping the first ear and a second wrapping enveloping the second ear, the wrappings each comprising a transparent film; and
a corn holder comprising at least a first ear holding compartment and a second ear holding compartment, wherein the first ear is vertically positioned in the first ear holding compartment and the second ear is vertically positioned in the second ear holding compartment,
(b) obtaining a shipping container marked with a label indicating which side of the container should remain up during shipping;
(c) packing each of the plurality of units of packaged corn in the shipping container with the ears of corn arranged vertically when the side of the container that should remain up during shipping is up; and
(d) transporting the packed shipping container from a first location to a second location located at least 1 kilometer from the first location.
